(19) United States
(12) Patent Application Publication
(10) Pub. No.: US 2010/0147261 A1
(43) Pub. Date: Jun. 17, 2010

(54) GASOLINE ENGINE

(75) Inventors: Junichi YAMAGUCHI, Tokai (JP); Shinya MATOHARA, Hitachinaka (JP); Masahiko Inoue, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/337,760

(22) Filed: Dec. 18, 2008

(30) Foreign Application Priority Data
Dec. 15, 2008 (JP) 2008-006007

(51) Int. Cl. F02B 17/00

(52) U.S. Cl. 123/295; 123/299

(57) ABSTRACT

A gasoline engine is provided that effectively uses two injectors to enhance homogeneity of mixture at the time of high-load for improving output power and to enable stable operation also when stratified or weak stratified combustion is performed.

One cylinder is provided with a first injector 122a and a second injector 122b, which directly inject fuel into the cylinder. An ECU 201 uses one or both the injectors to perform fuel injection during one combustion cycle depending on operating conditions.

### BACKGROUND OF THE INVENTION

1. Field of the Invention

The present invention relates generally to gasoline engines that directly inject fuel into a cylinder and burn it mainly by ignition, and more specifically, to a gasoline engine provided with twin-injectors.

2. Description of the Related Art

In-cylinder injection type spark ignition gasoline engines (DI-G engines), which directly inject fuel into a cylinder, have widely been known in the art. They can significantly make a total air-fuel ratio lean by subjecting mixture around an ignition plug to stratification, compared with an engine provided with a multi-port injection system (MPi system) which has predominated. This can achieve a reduction in fuel consumption and an improvement in output power resulting from an intake air cooling effect and from improved combustion efficiency.

In addition, the following method is widely known as a technology characterized by the engines of such a type. Fuel is injected in a compression stroke at the time of start-up to cause mixture to be eccentrically present in the vicinity of an ignition plug and at the same time ignition timing is retarded. This intentionally increases a combustion portion not leading to effective torque, i.e., the proportion of afterburning to thereby increase exhaust temperature. Thus, activation of a catalyst is accelerated to thereby reduce unburned carbon hydride (HC) in exhaust gas.

For a key technology adapted to appropriately perform such stratified and homogeneous combustion, it is important to supply appropriate fuel to a necessary position as required for satisfactory formation of mixture. In view of this point, the so-called twin-injector system is known which is provided with two injectors, per cylinder, which directly inject fuel into a cylinder (see, for example, JP-A-2007-32437).

The twin-injector system described in JP-A-2007-32437 is provided in a cylinder with two injectors, specifically, a first injector adapted to inject a hollow cone spray along a cylinder centerline from above a combustion chamber, and a second injector adapted to inject a sector spray from the vicinity of an intake port. In addition, this system separately uses them in accordance with purposes to thereby enable more appropriate formation of mixture than ever before.

For example, in a high-load range, the first injector injects fuel in an intake stroke to form a uniform mixture and the second injector injects fuel in a compression stroke to promote the flow of the mixture in a cylinder for accelerating combustion, thereby preventing knocking.

Further, in order to perform homogeneous combustion, in the intake stroke, only the first injector injects fuel and the second injector stops injection, thereby enabling efficient formation of a homogeneous mixture.

On the other hand, in the case where the start-up ignition retard combustion mentioned above is performed, the first injector first injects fuel to form a uniform base mixture in the intake stroke and next the second injector injects fuel in the compression stroke to form a slightly rich mixture in the vicinity of an ignition plug provided above the combustion chamber. Thus, satisfactory combustion can be performed even at the time of ignition retard to accelerate the rising temperature of the catalyst.

### SUMMARY OF THE INVENTION

However, the spray forms provided by the twin-injector system described in JP-A-2007-32437 are the hollow cone spray of the first injector and the fan spray of the second injector. Therefore, the system cannot always form mixture with an optimum distribution.

For example, if the start-up ignition retard combustion mentioned above is performed, ignition timing for the second fan-spray injector cannot always optimally be set in the compression stroke. Consequently, fuel may remain on the piston to cause unburned fuel (HC), soot, and the like in some cases.

In addition, mixture cannot always optimally be formed at the place of the ignition plug; therefore, extra fuel is required and combustion tends to become unstable, which poses a problem in that a sufficient amount of ignition retard cannot be ensured.

Because of this, since ignition timing must be set on the advance angle side relative to the plan, afterburning cannot sufficiently be performed. In addition, the time for warming up the catalyst is elongated to increase emissions such as HC and the like. The time from fuel injection to ignition, i.e., evaporation time cannot sufficiently be elongated. This poses a problem in that soot (particulate matter) resulting from the diffusive combustion of unburned fuel cannot sufficiently be reduced.

Also during the homogeneous combustion, when the mixture is formed only by the first injector, i.e., only through the direct-above type hollow cone spray, the diffusion of the fuel spray unavoidably tends to become insufficient depending on operating conditions. In addition, utilization of air, particularly, close to the wall surface cannot be increased compared with that of the conventional system. This poses a problem in that the homogeneity of the mixture is impaired not to provide sufficient output power.

If an spray angle is increased to increase the utilization of air close to the wall surface, spray colliding with the cylinder wall increases to increase soot, that is, deteriorate emissions such as HC and the like, which poses a problem of causing the lowering of output power.

Further, while not disclosed by JP-A-2007-32437 mentioned above, a flow rate of fuel injected by the injector tends to fail in a high-load high-speed range especially when supercharging is performed. To make up for such a deficiency, if the nozzle hole diameter of the injector is increased, a controllable minimum amount of injection is increased when low-load operation such as idle operation or the like is performed. This poses a problem in that fuel injection amount control cannot be exercised more accurately, that is, the so-called dynamic range becomes insufficient.

If the nozzle hole diameter of the injector is increased in this case, fuel particles become coarse, which poses a problem of an increase in evaporation time leading to deterioration in emissions such as unburned fuel (HC), soot and the like.

These descriptions are summed up that the two types of injectors are insufficiently coordinated so that effects such as enlargement of the dynamic range, an improvement in homogeneity, lowering of emissions and the like cannot sufficiently be provided.

It is a first object of the present invention to provide a gasoline engine that effectively uses two injectors to enhance homogeneity of mixture at the time of high-load for improving output power and to provide stable operation also when stratified or weak stratified combustion is performed.

It is a second object of the present invention to provide a gasoline engine that optimizes mixture formation to ensure a sufficient ignition retard amount immediately after start-up, which increases exhaust temperature to accelerate activation of a catalyst, thereby reducing HC, and that ensures the elongate evaporation time of fuel to reduce soot.

(1) To achieve the above objects, one aspect of the invention is that in a gasoline engine for injecting fuel directly to cylinders by injectors, wherein two injectors are provided for each cylinder, and one or both the injectors are used for fuel injection within one combustion cycle depending on an operating condition.

With such a configuration, the two injectors are effectively used to enhance the homogeneity of the mixture at high-load to improve output power and to stably operate the engine also when the stratified or weak stratified combustion is performed.

(2) In item (1) described above, preferably, the two injectors are used to form a weak stratified mixture in the entire cylinder during cold-engine operation immediately after start-up, and a stratified mixture richer than an average air-fuel ratio of the entire cylinder around an ignition plug.

(3) In item (1) described above, preferably, of the two injectors, a first injector is disposed above a combustion chamber to open in the vicinity of the center of a cylinder head, and a second injector is disposed to open at a position below the cylinder head and between two intake ports.

(4) In item (1) described above, preferably, of the two injectors, a first injector is disposed to open at a position below a cylinder head and between two intake ports and a second injector is disposed to open at a position below a cylinder head and between two exhaust ports.

(5) In item (3) or (4) described above, preferably, one of the two injectors has a spraying direction faced upward of the cylinder, i.e., toward the direction of the cylinder head, and the other has a spraying direction faced downward of the cylinder, i.e., toward the direction of a piston.

(6) In item (3) or (4) described above, preferably, of the two injectors, one located above the combustion chamber or close to the exhaust ports is made to have weak penetration and the other located close to the intake ports is made to have intense penetration.

(7) In item (3) or (4) described above, preferably, of the two injectors, one located above the combustion chamber or close to the exhaust ports is made to have intense penetration and the other located close to the intake ports is made to have weak penetration.

(8) In item (3) described above, preferably, if the engine is mainly operated on stratified combustion, of the two injectors, only one located above the combustion chamber performs fuel injection and if the engine is operated on homogeneous combustion, both the two injectors perform fuel injection.

(9) In item (1) described above, preferably, of the two injectors, an injector mainly used for intake stroke injection has a flow rate different from that of the other injector and an injector mainly used for compression stroke injection has a nozzle hole diameter and the number of nozzle holes different from those of the other injector.

(10) In item (1) described above, preferably, respective pressures of fuel supplied to the two injectors are made different from each other.

(11) In addition, to achieve the above objects, another aspect of the invention is that in a gasoline engine for injecting fuel directly to cylinders by injectors,

the two injectors are used to form a weak stratified mixture in the entire cylinder during cold-engine operation immediately after start-up, and a stratified mixture richer than an average air-fuel ratio of the entire cylinder around an ignition plug.

With such a configuration, since the mixture formation can be optimized, a sufficient ignition retard amount can be ensured immediately after start-up to increase exhaust temperature. This achieves the early activation of the catalyst and reduces HC and ensures the long evaporation time of fuel, thereby providing reduced soot.

According to the present invention, the two injectors are effectively used to enhance homogeneity of mixture at the time of high-load for improving output power and to enable stable operation also when stratified or weak stratified combustion is performed.

In addition, the mixture formation is optimized to ensure a sufficient amount of ignition retard immediately after start-up, which increases exhaust temperature to accelerate activation of a catalyst, thereby reducing HC, and to ensure the elongate evaporation time of fuel to reduce soot.

### BRIEF DESCRIPTION OF THE DRAWINGS

FIG. 1 is a system configuration diagram of a gasoline engine according to an embodiment of the present invention.

FIG. 2 is a system configuration diagram of the gasoline engine according to the embodiment.

FIG. 3 is a diagram for assistance in explaining the positional relationship among spray of a second injector, a piston, and an ignition plug of the gasoline engine according to the embodiment.

FIG. 4 is a diagram for assistance in explaining the positional relationship among the spray of the second injector, piston, and ignition plug of the gasoline engine according to the embodiment.

FIG. 5 is a diagram for assistance in explaining a combustion state of each operating range after warm-up in the gasoline engine according to the embodiment.

FIG. 6 is a diagram for assistance in explaining a combustion state in a low and middle-speed, middle and high-load range in the gasoline engine according to the embodiment.

FIG. 7 is a diagram for assistance in explaining a combustion state in a low and middle-speed, middle and high-load range in the gasoline engine according to the embodiment.

FIG. 8 is a diagram for assistance in explaining a combustion state in a high-speed high-load range in the gasoline engine according to the embodiment.

FIG. 9 is a diagram for assistance in explaining a combustion state in a high-speed high-load range in the gasoline engine according to the embodiment.

FIG. 10 is a diagram for assistance in explaining a combustion state in a high-speed low-load range in the gasoline engine according to the embodiment.

FIG. 11 is a diagram for assistance in explaining a combustion state in a high-speed low-load range in the gasoline engine according to the embodiment.

FIG. 12 is a diagram for assistance in explaining a combustion state in a low-speed low-load range in the gasoline engine according to the embodiment.

FIG. 13 is a diagram for assistance in explaining a combustion state in a low-speed low-load range in the gasoline engine according to the embodiment.

FIGS. 14A to 14D are diagrams for assistance in explaining performance of a conventional example and of the present embodiment during low-speed with low-load after warm-up in the gasoline engine according to the embodiment.

FIGS. 15A to 15D are diagrams for assistance in explaining performance of a conventional example and of the present embodiment during high-speed with high-load after warm-up in the gasoline engine according to the embodiment.

FIG. 16 is a diagram for assistance in explaining a state of a combustion chamber, in a first example, of the gasoline engine according to the embodiment, at the time of low-speed with low-load during cold-engine operation immediately after start-up.

FIG. 17 is a diagram for assistance in explaining a state of the combustion chamber, in the first example, of the gasoline engine according to the embodiment at the time of low-speed with low-load during cold-engine operation immediately after start-up.

FIG. 18 is a diagram for assistance in explaining a state of the combustion chamber, in the first example, of the gasoline engine according to the embodiment at the time of low-speed with low-load during cold-engine operation immediately after start-up.

FIG. 19 is a diagram for assistance in explaining a state of a combustion chamber, in a second example, of the gasoline engine according to the embodiment, at the time of low-speed with low-load during cold-engine operation immediately after start-up.

FIG. 20 is a diagram for assistance in explaining a state of the combustion chamber, in the second example, of the gasoline engine according to the embodiment, at the time of low-speed with low-load during cold-engine operation immediately after start-up.

FIG. 21 is a diagram for assistance in explaining a state of the combustion chamber, in the second example, of the gasoline engine according to the embodiment, at the time of low-speed with low-load during cold-engine operation immediately after start-up.

FIG. 22 is a diagram for assistance in explaining a state of the combustion chamber, in a third example, of the gasoline engine according to the embodiment, at the time of low-speed with low-load during cold-engine operation immediately after start-up.

FIG. 23 is a diagram for assistance in explaining a state of the combustion chamber, in the third example, of the gasoline engine according to the embodiment, at the time of low-speed with low-load during cold-engine operation immediately after start-up.

FIG. 24 is a diagram for assistance in explaining a state of the combustion chamber, in the third example, of the gasoline engine according to the embodiment, at the time of low-speed with low-load during cold-engine operation immediately after start-up.

FIG. 25 is a diagram for assistance in explaining a state of the combustion chamber, in a fourth example, of the gasoline engine according to the embodiment, at the time of low-speed with low-load during cold-engine operation immediately after start-up.

FIG. 26 is a diagram for assistance in explaining a state of the combustion chamber, in the fourth example, of the gasoline engine according to the embodiment, at the time of low-speed with low-load during cold-engine operation immediately after start-up.

FIG. 27 is a diagram for assistance in explaining a state of the combustion chamber, in the fourth example, of the gasoline engine according to the embodiment, at the time of low-speed with low-load during cold-engine operation immediately after start-up.

FIG. 28 is a diagram for assistance in explaining a state of the combustion chamber, in a fifth example, of the gasoline engine according to the embodiment, at the time of low-speed with low-load during cold-engine operation immediately after start-up.

FIG. 29 is a diagram for assistance in explaining a state of the combustion chamber, in the fifth example, of the gasoline engine according to the embodiment, at the time of low-speed with low-load during cold-engine operation immediately after start-up.

FIG. 30 is a diagram for assistance in explaining a state of the combustion chamber, in the fifth example, of the gasoline engine according to the embodiment, at the time of low-speed with low-load during cold-engine operation immediately after start-up.

FIG. 31 is a diagram for assistance in explaining a state of the combustion chamber of the gasoline engine according to the embodiment, at the low-speed with low-load after warm-up in the case where control is exercised on the low-speed with low-load during cold-engine operation immediately after start-up in the fifth example.

FIG. 32 is a flowchart illustrating control contents at the time of start-up in the gasoline engine according to the embodiment of the invention.

FIG. 33 is a diagram for assistance in explaining a change in HC emissions, in soot amount and in exhaust temperature encountered when ignition timing is changed.

FIGS. 34A to 34D are diagrams for assistance in explaining performance of a conventional example and of the present embodiment during low-speed low-load after start-up in the gasoline engine according to the embodiment.

### DESCRIPTION OF THE PREFERRED EMBODIMENTS

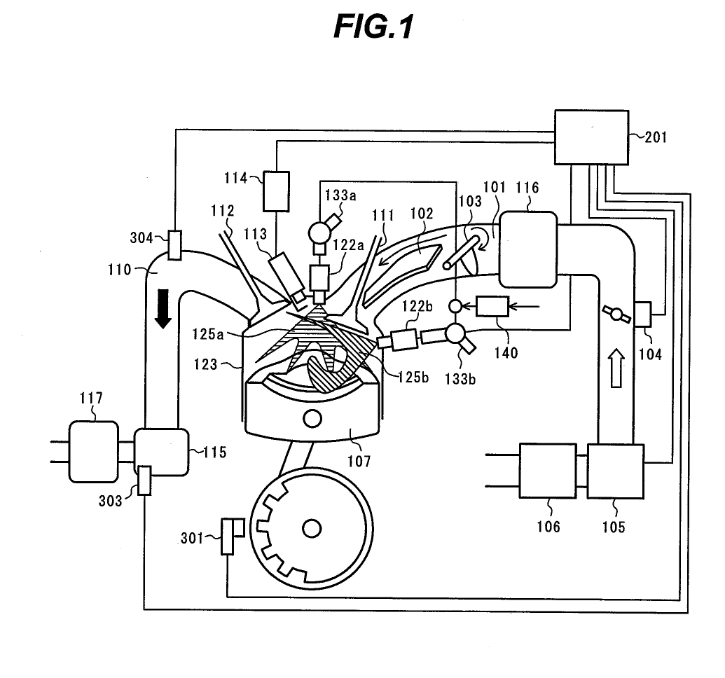

Configurations of gasoline engines according to embodiments of the present invention will hereinafter be described with reference to FIGS. 1 through 34.

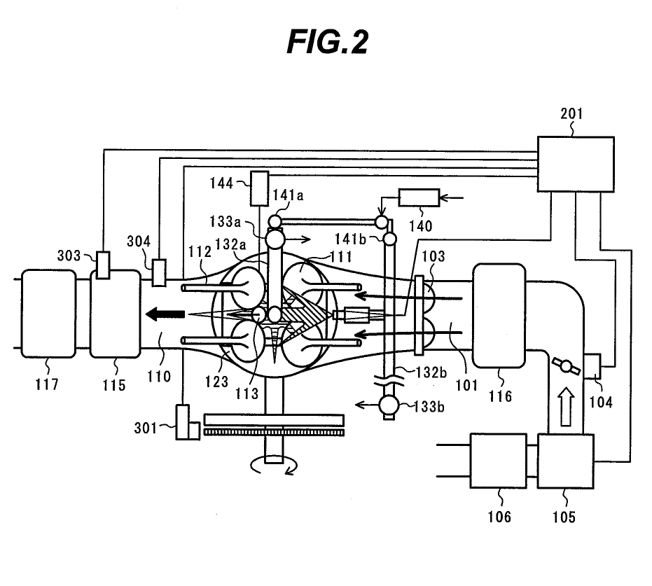

A description is first given of a configuration of a gasoline engine system according to the present embodiment with reference to FIGS. 1 and 2.

FIGS. 1 and 2 are system configuration diagrams of the gasoline engine according to the embodiment of the invention. FIG. 1 illustrates an intake system and an exhaust system as viewed from the general side and FIG. 2 as viewed from above of the engine. It is to be noted that while the embodiment mainly assumes a multi-cylinder engine, one cylinder is described with subsequent views for simplicity.

In FIGS. 1 and 2, an intake pipe 101 is divided into upper and lower portions by a partition plate 102 in an interval between an end face of a cylinder 123 and an intake control valve 103. The intake control valve 103 provided in an upstream portion is installed to close a lower side passage of the intake pipe 101.

A first injector 122a is installed so as to directly inject fuel from the vicinity of the top of a cylinder 123 toward the downside, i.e., toward a piston 107, forming spray 125a. The injector has a plurality of nozzle holes, that is, is of a type generally called a multi-hole injector.

Incidentally, the nozzle holes of the first injector 122a are disposed close to the gap of an ignition plug 113, specifically, disposed to open at a location within 15 mm therefrom.

A second injector 122b is installed at a lower portion of the cylinder 123 put between two intake valves 111 to inject fuel toward an exhaust side, forming spray 125b. Also the second injector 122b has a plurality of nozzle holes similarly to the first injector 122a.

The second injector 122b is configured to inject fuel spray from one or more of the nozzle holes toward the ignition plug 113.

The first and second injectors 122a, 122b are configured to have such a full injection flow rate that the flow ratio of the first and second injectors 122a, 122b is from 5:1 to 5:5. Preferably, the flow ratio is set to 5:3. To that end, specifically, the nozzle hole diameters or orifice diameters of the second injector 122b are made smaller than those of the first injector 122a. Also the number of the nozzle holes of the multi-hole injector is, as required, such that the second injector 122b is made to have four to six nozzle holes if the first injector 122a has six to eight.

Air is sucked from the lower right of FIGS. 1 and 2 and passes through an air cleaner 106. Then, the flow rate of the air is measured by an airflow meter 105 and regulated by an electronic control throttle 104. Subsequently, the air is distributed into the cylinders at a collector 116. Thereafter, the air distributed passes through the intake pipe 101 and flows into the cylinder 123 upon opening of the intake valve 111. Gas resulting from combustion in the cylinder 123 passes through an exhaust valve 112, an exhaust pipe 110, a catalyst 115, and a silencer 117, and is discharged to the atmosphere.

On the other hand, fuel from a fuel tank not shown is pressurized by a fuel pump 140, sequentially passes through a non-return valve 141a and a fuel gallery 132a which is a common rail adapted to supply fuel to the first injector 122a, and is injected from the first injector 122a. In addition, the fuel pressurized sequentially passes through a non-return valve 141b and through a fuel gallery 132b adapted to feed fuel to the second injector 122b and is injected from the second injector 122b.

The respective pressures of the fuel galleries 132a and 132b are measured and controlled by fuel pressure sensor integrated type pressure regulators 133a and 133b, respectively. More specifically, the fuel pressure can be maintained at a set value by controlling an amount of fuel retuning to the fuel tank not shown in response to control signals given to the pressure regulators from an engine control unit (ECU) 201. The values of the fuel pressures may be different between the first and second injectors 122a, 122b and can arbitrarily be used to make appropriate the respective flow rates of the injectors, and the degree of atomization and of penetration.

The fuel injection timings of the injectors 122a, 122b, the ignition timing of the ignition plug 113, and the opening angle of the intake control valve 103 and of the electronic control throttle 104 are set and controlled to corresponding optimum timings and values by the engine control unit (ECU) 201 based on the following data: the intake air quantity measured by the air flow meter 105, fuel pressures in the fuel galleries 132a, 132b measured by respective associated fuel pressure sensors 133a, 133b attached thereto, engine speed obtained by a crank angle sensor 301, the opening angle of an accelerator pedal, engine water temperature, vehicle speed (their input side sensors are not illustrated in the figures), and information from a catalyst temperature sensor 303 and from an exhaust temperature sensor 304, etc.

As regards ignition, the engine control unit (ECU) 201 gives an ignition pulse signal to an ignition coil 114 to generate high voltage, which causes the ignition plug 113 to strike an ignition spark.

As regards fuel injection, the engine control unit (ECU) 201 gives an injection pulse signal to the first injector 122a or the second injector 122b, which performs operation for a valve-opened period corresponding to such a signal. Incidentally, the actual fuel injection amount varies depending on this valve-opened period and the pressure in the fuel galleries 132a, 132b measured by the corresponding fuel pressure sensors 133a, 133b; therefore, the engine control unit (ECU) 201 determines a pulse width allowing for such fuel pressure.

If determining that the engine requires air flow, e.g., during the low-load of the engine, the engine control unit (ECU) 201 controls the intake control valve 103 in a closing direction to provide more optimum tumble intensity.

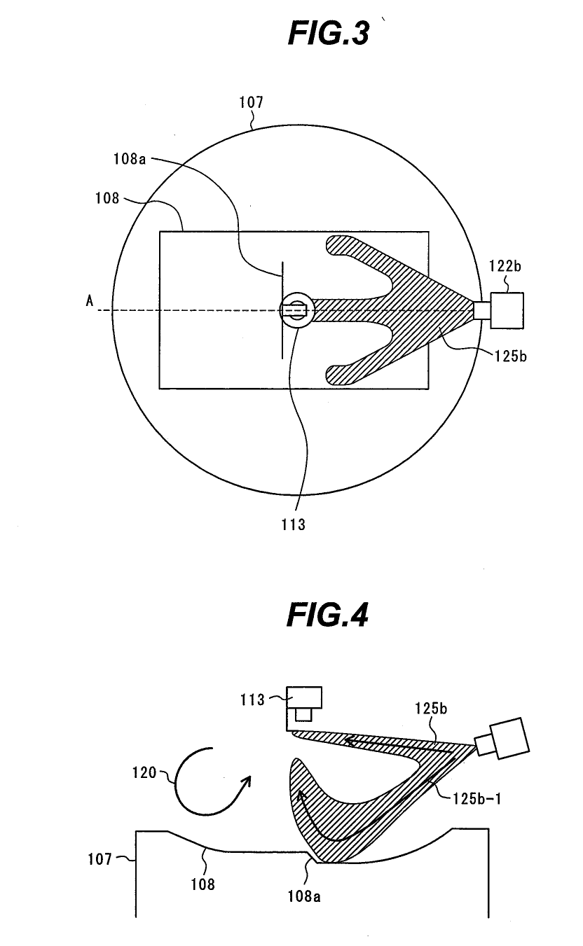

A description is next given of the positional relationship among the spray of the second injector, the piston and the ignition plug of the gasoline engine according to the present embodiment with reference to FIGS. 3 and 4.

FIGS. 3 and 4 are diagrams for assistance in explaining the positional relationship among the spray of the second injector, the piston and the ignition plug of the gasoline engine according to the embodiment of the invention. FIG. 3 illustrates the vicinity of a combustion chamber as viewed from above of the engine and FIG. 4 as viewed from the general side. Incidentally, in FIGS. 3 and 4 the same reference numerals as those in FIGS. 1 and 2 denote the same portions.

A tumble retention cavity 108 is provided on the piston 107 to form a recessed surface. Flow from the intake pipe 101 shown in FIGS. 1 and 2 is retained as a tumble 120 along the recessed surface so as to turn in the cylinder 123. On the other hand, spray 125b-1 injected downward, of spray 125b injected from the second injector 122b, proceeds along the tumble retention cavity 108. A step 108a is provided at a general center of the piston 107. The tumble 120 causes the spray 125b to curl up toward the vicinity of the ignition plug 113 with the step 108a acting as a trigger. A stable stratified mixture can be formed in the vicinity of the ignition plug 113 by using the second injector 122b in the second half of the compression stroke, preferably, in a range from 50° to 20° before top dead center.

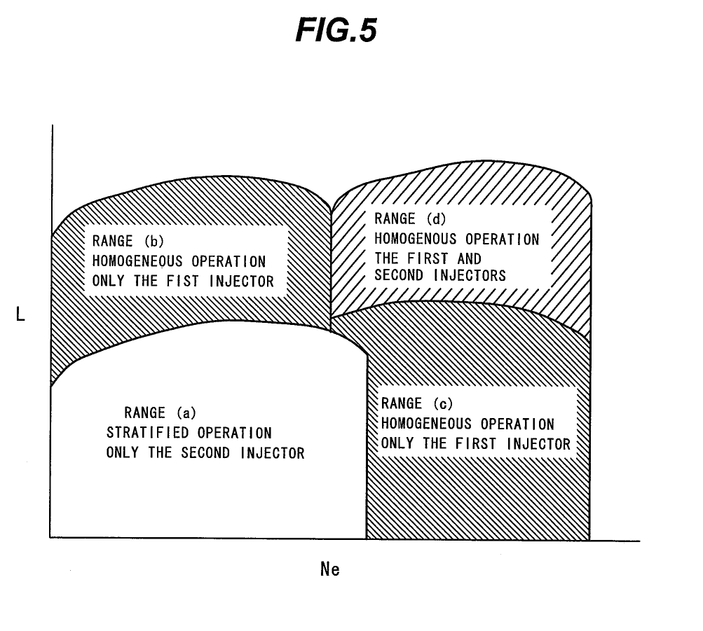

A description is next given of a combustion state for each of operating ranges after warm-up in the gasoline engine of the embodiment with reference to FIGS. 5 through 15.

At first, FIG. 5 is used to describe a combustion state for each of operating ranges after warm-up in the gasoline engine of the embodiment.

FIG. 5 is a diagram for assistance in explaining a combustion state for each of operating ranges after warm-up in the gasoline engine of the embodiment according to the present invention. In FIG. 5, an abscissa axis represents engine speed Ne and an ordinate axis a load L.

As regards the combustion state for each of operating ranges after warm-up in the present embodiment, in a relatively low-load low-speed range A the second injector is used to perform stratified operation, whereby a lean air-fuel ratio suppresses a pumping loss to reduce fuel consumption. In the other ranges, i.e., in a low and middle-speed, middle and high-load range B, a high-speed low-load range C, and a high-speed high-load range D, homogeneous operation is carried out. However, in the ranges B and C, injection is performed only by the first injector to improve the degree of homogeneity. In the range D, both the first and second injectors are used to inject the large flow of fuel to deal with high output power.

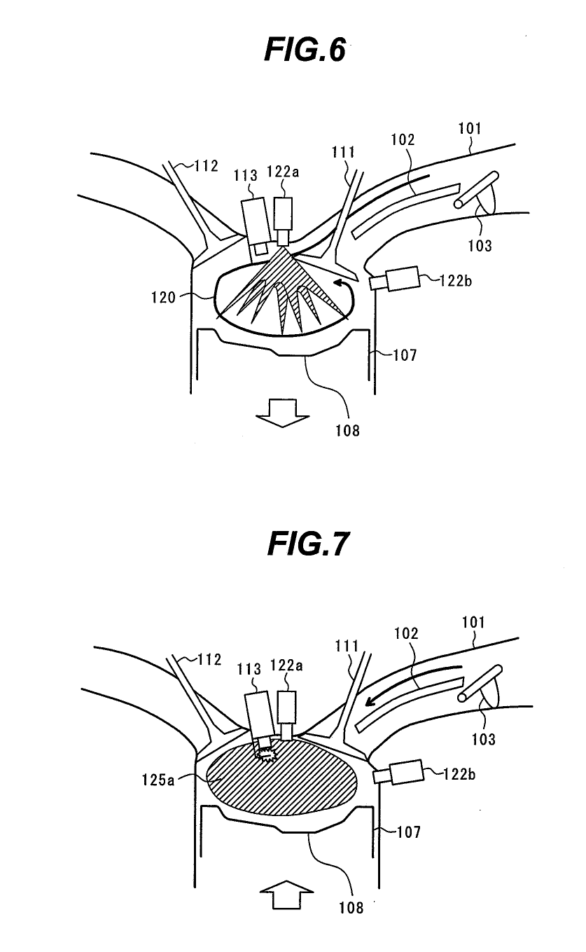

The ECU 201 determines which one of the first and second injectors should be used by determining the above-mentioned ranges based on information about the engine speed Ne and load L. The operation of each range is detailed later by use of FIGS. 6 through 13.

A description is next given of a combustion state of the gasoline engine according to the embodiment in the lower and middle-speed, middle and high-load range by use of FIGS. 6 and 7.

FIGS. 6 and 7 are diagrams for assistance in explaining the combustion state of the gasoline engine of the embodiment in the lower and middle-speed middle and high-load range. It is to be noted that in FIGS. 5 and 6 the same reference numerals as those in FIGS. 1 and 2 denote like portions.

FIGS. 6 and 7 illustrate a state of an intake stroke and that of a compression stroke near ignition timing, respectively. These states correspond to the range B of FIG. 5.

In this case, the engine speed is low or middle-speed greater than idle speed. The engine control unit (ECU) 201 selects intake stroke injection, i.e., homogeneous combustion. In addition, load is in a middle or high-load state. At this time, the engine control unit (ECU) 201 shown in FIGS. 1 and 2 issues an instruction to set the intake control valve 103 in an opening direction, so that much air passes through the intake valve 111 and is sucked into the cylinder 123. In this case, fuel is injected from the first injector 122a disposed at the upper portion of the cylinder in the intake stroke, specifically, from 200 after top dead center to the vicinity of 20° before bottom dead center. Since the engine is not faster than middle-speed, the engine can take relatively long evaporation time. Thus, fuel adhering to a cylinder wall is little and mixing of air with fuel is promoted to thereby provide high-torque.

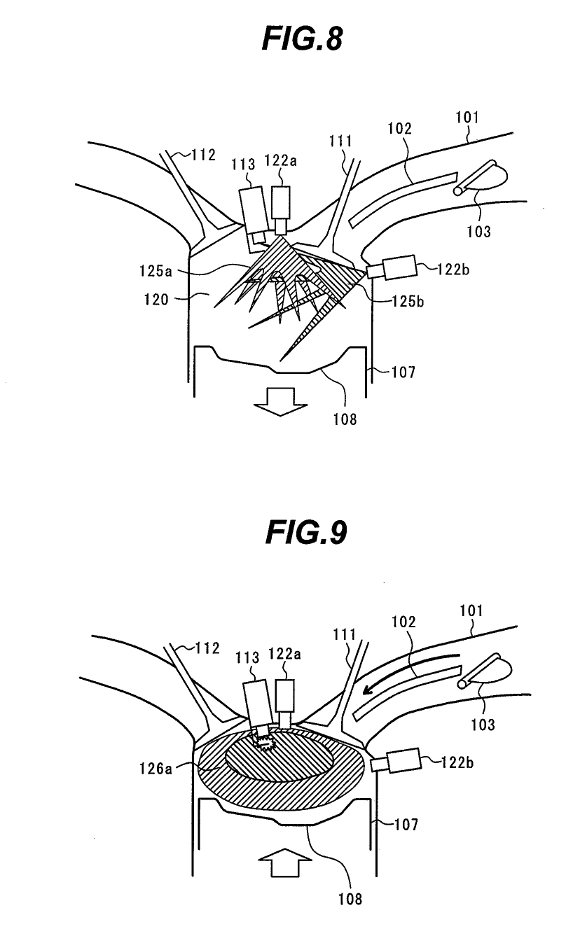

A description is next given of a combustion state of the gasoline engine according to the embodiment in a high-speed, high-load range with reference to FIGS. 8 and 9.

FIGS. 8 and 9 are diagrams for assistance in explaining the combustion state of the gasoline engine of the embodiment in the high-speed, high-load range. It is to be noted that in FIGS. 8 and 9 the same reference numerals as those in FIGS. 1 and 2 denote like portions.

FIGS. 8 and 9 illustrate the state of the intake stroke and that of the compression stroke near ignition timing, respectively. These states are associated with the range D of FIG. 5.

In this case, the engine control unit (ECU) 201 shown in FIGS. 1 and 2 selects intake stroke injection, i.e., homogeneous combustion. The intake control valve 103 is set in a more opening direction than in the case of FIGS. 6 and 7. Much air passes through the intake valve 111 and is sucked into the cylinder 123.

Unlike the case shown in FIG. 6, in the case where the intake stroke injection is carried out in the high-speed range, only the spray 125a of the first injector 122a provides an insufficient amount of fuel injection and an insufficient period of injection. Accordingly, also the second injector 122b performs injection in the intake stroke. Both the injection periods of the first and second injectors are set to a range, e.g., from top dead center to bottom dead center. In this way, sprays 125a, 125b are supplied into the cylinder 123 and thereafter the homogeneous mixture 126a of FIG. 9 is formed through the compression stroke. Then, ignition is performed at ignition timing, e.g., 10° before top dead center. With these constitutions, mixing of air with fuel is promoted to increase air utilization while ensuring a sufficient amount of fuel, thereby advancing ignition timing to provide high-power while suppressing soot and occurrence of knocking.

One of the features of the embodiment is to use both the first and second injectors 122a, 122b in one combustion cycle for fuel injection.

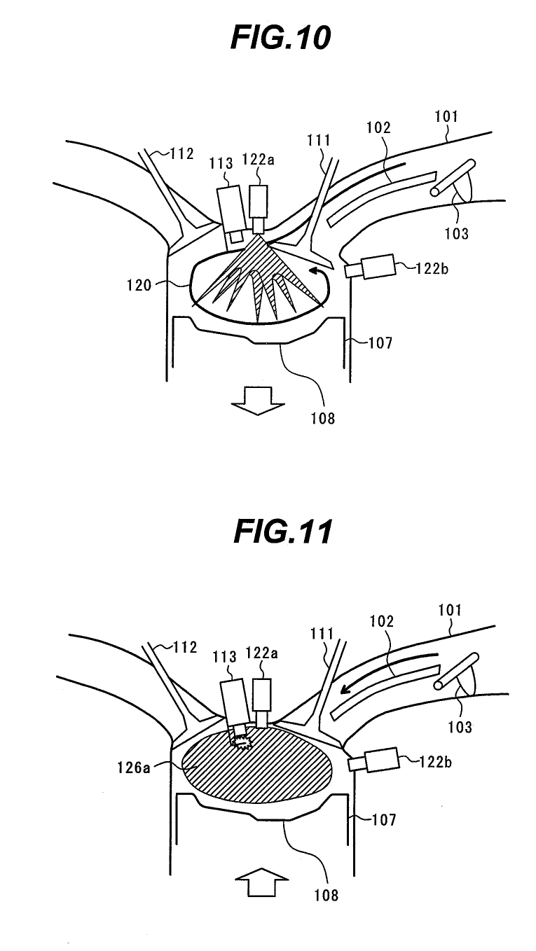

A description is next given of a combustion state of the gasoline engine according to the embodiment in a high-speed, low-load range with reference to FIGS. 10 and 11.

FIGS. 10 and 11 are diagrams for assistance in explaining the combustion state of the gasoline engine of the embodiment of the invention in the high-speed, low-load range. It is to be noted that in FIGS. 10 and 11 the same reference numerals as those in FIGS. 1 and 2 denote like portions.

FIGS. 10 and 11 illustrate the state of the intake stroke and that of the compression stroke, respectively. These states are associated with the range C of FIG. 5.

In this case, the engine control unit (ECU) 201 shown in FIGS. 1 and 2 selects intake stroke injection, i.e., homogeneous combustion. Unlike the other operating states, the intake control valve is set in a slightly closing direction. In this case, only the first injector 122a injects fuel in the intake stroke, preferably, from 200 after top dead center to the vicinity of 40° before bottom dead center. After the compression stroke, ignition is performed at ignition timing, e.g., 20° before top dead center. Because of lower-speed and sufficient time, vaporization of fuel and mixing of fuel with air can be promoted to thereby enable sufficiently satisfactory combustion.

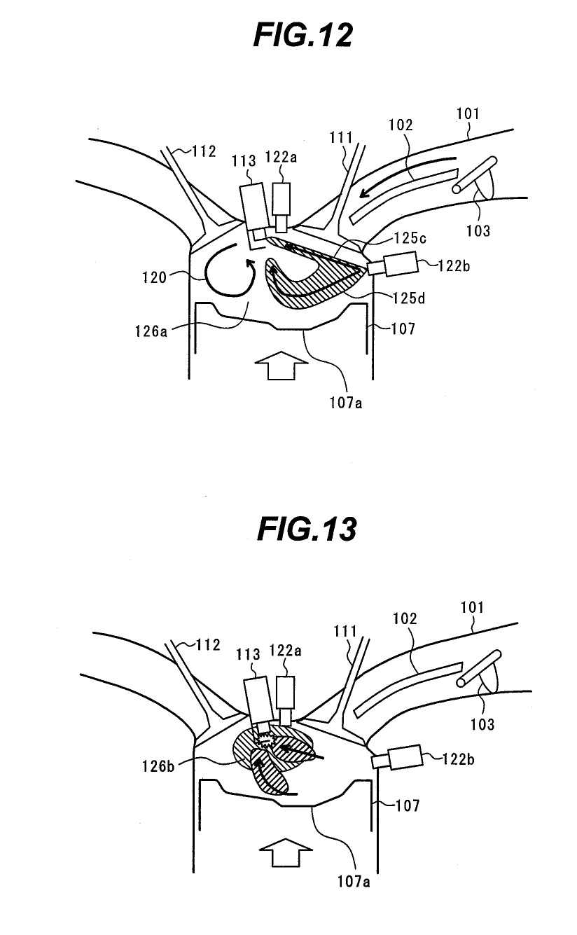

A description is next given of a combustion state of the gasoline engine according to the embodiment in a low-speed, low-load range with reference to FIGS. 12 and 13.

FIGS. 12 and 13 are diagrams for assistance in explaining the combustion state of the gasoline engine of the embodiment of the invention in the low-speed, low load range. It is to be noted that in FIGS. 12 and 13 the same reference numerals as those in FIGS. 1 and 2 denote like portions.

FIGS. 12 and 13 illustrate the state of the intake stroke and that of the compression stroke near ignition timing, respectively. These states are associated with the range A of FIG. 5.

The engine control unit (ECU) 201 shown in FIGS. 1 and 2 selects compression stroke injection, i.e., stratified combustion. Similarly to the case of FIG. 5 described above, the intake control valve is set in a slightly closing direction. In this case, only the second injector injects fuel in the compression stroke, more specifically, from 50° to the vicinity of 20° before compression top dead center. Then, ignition is performed at ignition timing, e.g., 15° before top dead center.

Spray 125c proceeding toward the ignition plug 113, of the spray injected from the second injector 122b, is formed. This spray 125c vaporizes before reaching the vicinity of the ignition plug to form a stratified mixture.

Spray 125d proceeding toward a crown surface of the piston 107 is present, of the spray similarly injected from the second injector 122b. This spray 125d proceeds along the tumble retention cavity 108 provided on the piston 107, while mixing with the air in the cylinder 123, and is lifted toward the ignition plug 113 by being influenced by the tumble 120 inside the cylinder 123 generally below the ignition plug 113. Thus, a stable stratified mixture 126b is formed around the ignition plug 113 for a long period of time in the form of following the mixture deriving from the spray 125c. In this way, stable stratified combustion can be performed.

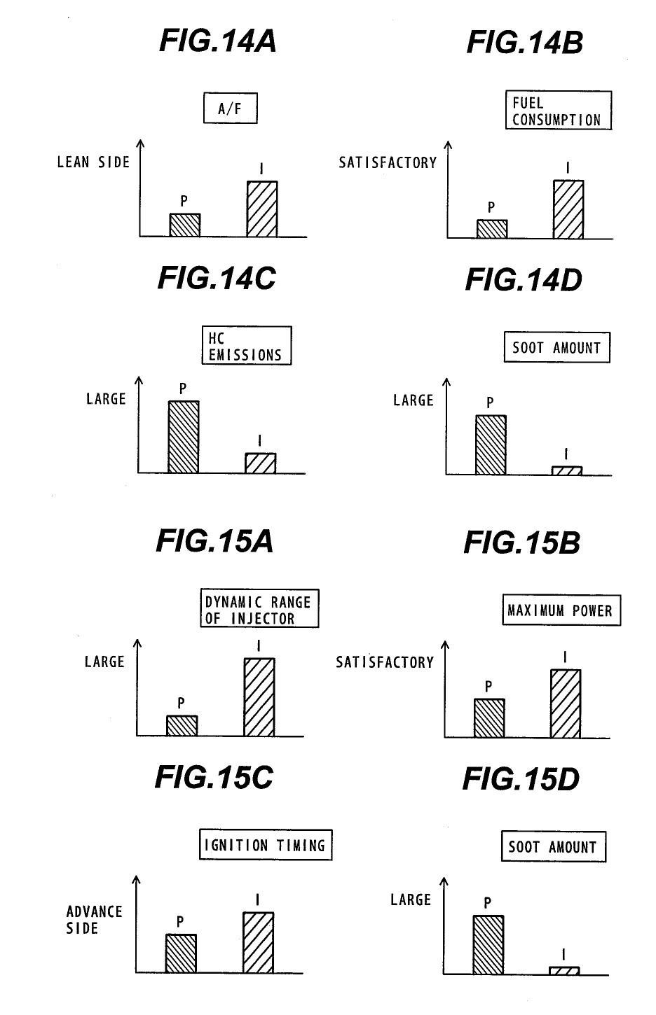

A description is next given of performance of a conventional example and of the present embodiment with respect to the gasoline engine according to the embodiment at low-speed low-load after warm-up in the engine according to the embodiment with reference to FIGS. 14A through 14D.

FIGS. 14A through 14D are diagrams for assistance in explaining performance of the conventional example and of the present embodiment at low-speed low-load after warm-up in the gasoline engine according to the embodiment of the invention.

In FIGS. 14A through 14D, FIG. 14A represents an air-fuel ratio (A/F) and FIG. 14B fuel consumption. In addition, FIG. 14C represents HC emissions and FIG. 14D an amount of soot (SOOT). In the figures, symbol P denotes conventional performance and symbol I performance of the present embodiment.

In the present embodiment, it is possible to very satisfactorily form a stratified mixture. In general, if mixture is made lean, a pumping loss can be reduced to increase fuel consumption; however, combustion velocity lowers, which results in unstable combustion or in an increased time loss and in turn fuel consumption may lowers in some cases. Therefore, it is not possible to make an air-fuel ratio lean so much.

However, in the present embodiment, although an air-fuel ratio is made lean as shown in FIG. 14A, a stoichiometric or rich mixture is made to exist in the vicinity of the ignition plug 113. Therefore, it is possible to keep initial combustion velocity fast to suppress inter-cycle variation and inter-cylinder variation, thereby providing satisfactory combustion. In addition, while suppressing deterioration in emissions as shown in FIG. 14C, it is possible to sufficiently reduce fuel consumption as shown in FIG. 14B.

Further, since the injector adapted to supply the stratified mixture is designed to have small nozzle holes, fuel atomization is satisfactory. Also this point can suppress possible abnormal combustion resulting from unburned fuel.

Furthermore, since the injector adapted to supply the stratified mixture is designed to provide a flow rate smaller than that of the injector for homogeneous mixture, it is superior in minute flow controllability. Even if injection is performed e.g. two or three times, the minute flow that has conventionally been impossible can accurately be injected to thereby increase the flexibility of mixture formation.

A description is next given of performance of a conventional example and of the present embodiment with respect to the gasoline engine according to the embodiment in a high-speed, high-load range after warm-up in the engine with reference to FIGS. 15A through 15D.

FIGS. 15A through 15D are diagrams for assistance in explaining performance of the conventional example and of the present embodiment in a high-speed, high-load range after warm-up in the gasoline engine according to the embodiment of the invention.

In FIGS. 15A through 15D, FIG. 15A illustrates a dynamic range of an injector and FIG. 15B maximum output. In addition, FIG. 15C illustrates ignition timing and FIG. 15D an amount of soot. In the figures, symbol P denotes conventional performance and symbol I performance of the present embodiment.

Because of ensuring minute flow controllability, the conventional injector is such that the injection amount has an upper limit, which makes it difficult to ensure a large dynamic range. Therefore, even if satisfactory formation of spray is performed, maximum output may sometimes be limited.

In the present embodiment, since concurrent injection is performed by the two injectors at the time of homogeneous combustion, a large flow rate can be obtained to thereby increase a dynamic range as shown in FIG. 15A. In addition, it is possible to generate a mixture having a higher degree of homogeneity than that of injection only by a single injector. This can increase air utilization. In addition, if supercharging is particularly performed, generation of soot resulting from the presence of an excessive rich region can be suppressed, as shown in FIG. 15D, to prevent knocking even in the high-load range. Thus, ignition timing is advanced as shown in FIG. 15C to thereby provide a higher power engine as sown in FIG. 15B.

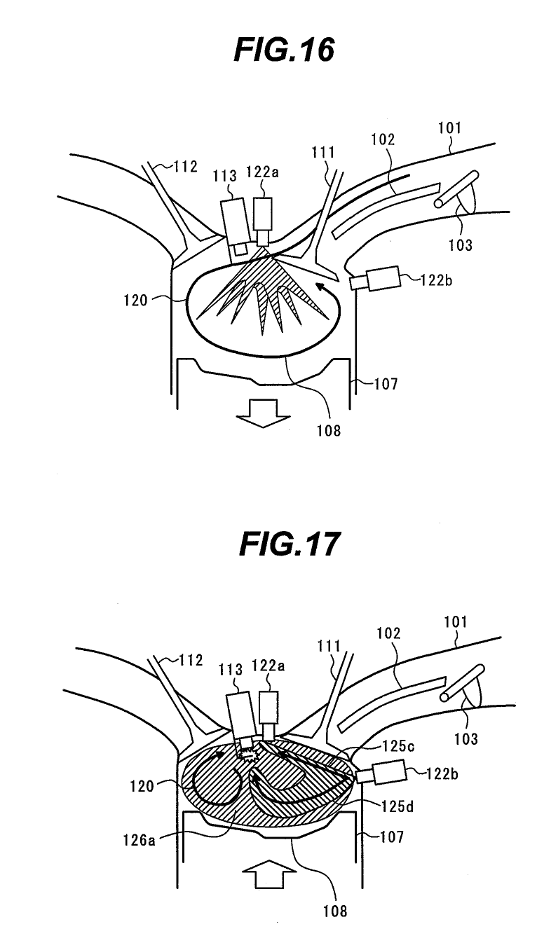

A description is next given of a state in the combustion chamber of the gasoline engine according to the embodiment during cold-engine operation immediately after start-up, with reference to FIGS. 16 through 34.

The present embodiment is characterized in that, during cold-engine operation immediately after start-up, a weak stratified mixture is formed in the entire cylinder and a stratified mixture richer than the average air-fuel ratio of the entire cylinder is formed around the ignition plug.

A description is first given of a state of the combustion chamber, in a first example, of the gasoline engine according to the present embodiment at the time of low-speed with low-load during cold-engine operation immediately after start-up with reference to FIGS. 16 to 18.

FIGS. 16 to 18 are diagrams for assistance in explaining the state of the combustion chamber, in the first example, of the gasoline engine according to the embodiment of the present invention at the time of low-speed with low-load during cold-engine operation immediately after start-up. It is to be noted that in FIGS. 16 to 18, the same reference numerals as those in FIGS. 1 and 2 denote like portions.

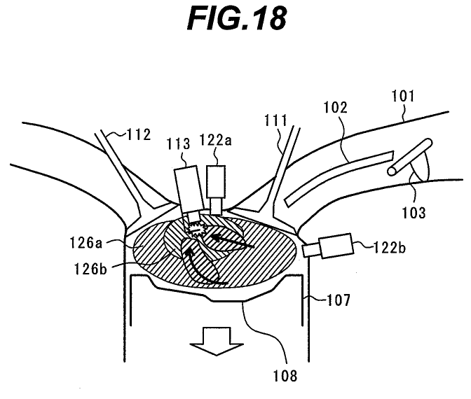

FIG. 16 illustrates the state of the intake stroke, FIG. 17 the state of the compression stroke, and FIG. 18 the state of an initial expansion stroke, i.e., of ignition timing.

At this time, it is necessary to increase exhaust temperature by ignition retard as described above to thereby early-activate the catalyst 115 shown in FIGS. 1 and 2.

To meet the necessity, the first injector 122a injects fuel during the intake stroke as shown in FIG. 16 and the second injector 122b injects fuel in the compression stroke as shown in FIG. 17. The behavior of the mixture during the intake stroke and during the compression stroke is the same as that illustrated in FIG. 6 and in FIG. 12, respectively.

The spray of the first injector forms the mixture 126a uniformly spreading in the cylinder 123 as shown in FIG. 16. As shown in FIG. 17 the spray of the second injector is such that both the spray 125c directly proceeding toward the vicinity of the ignition plug 113 and the spray 125d curling up toward the vicinity of the ignition plug 113 via the vicinity of the crown surface of the piston 107 form the stratified mixture 126b in the vicinity of the ignition plug.

As shown in FIG. 18, ignition is performed in the expansion stroke, preferably, from 5° and to about 30° after top dead center. Since the stratified mixture 126b richer than the average air-fuel ratio of the entire cylinder is stably present in the vicinity of the ignition plug 113 even at every crank angle, stable combustion can be performed at any ignition timing.

Incidentally, the ignition may be performed at a plurality of times in some cases. In such cases, ignitions are performed at certain intervals of ignition energy charging time at ignition timings, e.g., 20° and 30° after top dead center.

In this way, the weak stratified mixture is formed in the entire cylinder 123 to suppress the diffusion of the mixture even at the time of ignition retard. In addition, the stratified mixture richer than the average air-fuel ratio of the entire cylinder is formed around the ignition plug, thereby providing stable combustion.

Since ignition is slower than that of normal combustion, afterburning not leading to torque increases to elevate exhaust temperature. Thus, the catalyst 115 shown in FIGS. 1 and 2 is increased in temperature and early-activated to reduce emissions.

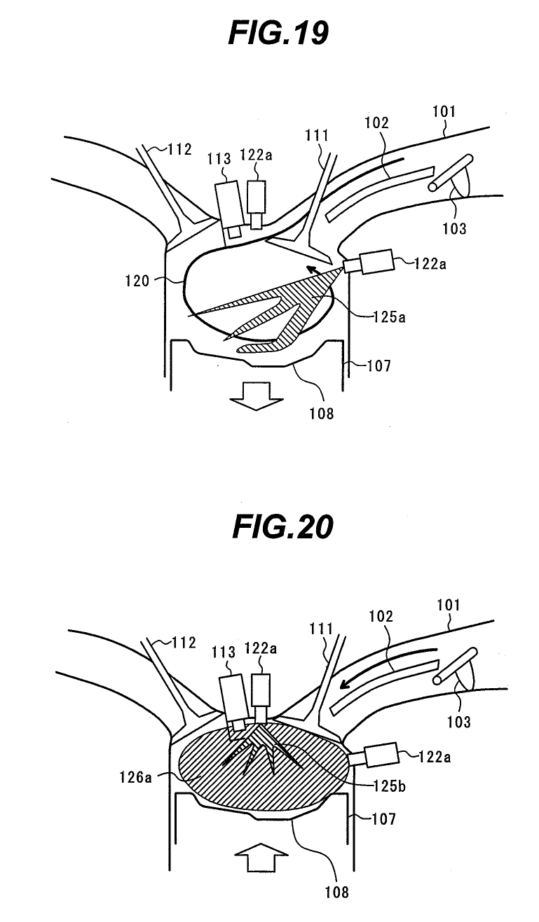

A description is next given of the state of the combustion chamber, in a second example, of the gasoline engine according to the present embodiment at the time of low-speed with low-load during cold-engine operation immediately after start-up, with reference to FIGS. 19 to 21.

FIGS. 19 to 21 are diagrams for assistance in explaining the state of the combustion chamber, in the second example, of the gasoline engine according to the embodiment of the present invention at the time of low-speed with low-load during cold-engine operation immediately after start-up. It is to be noted that in FIGS. 19 to 21, the same reference numerals as those in FIGS. 1 and 2 denote like portions.

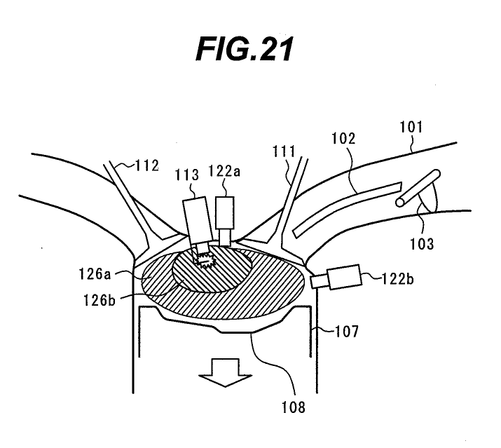

FIG. 19 illustrates the state of the intake stroke, FIG. 20 the state of the compression stroke, and FIG. 21 the state of an initial expansion stroke, i.e., of ignition timing.

In this example, as shown in the figures, the second injector mounted to the upper portion of the cylinder 123 is used to mainly form the stratified mixture and the first injector 122a disposed close to the intake valves 111 is used to mainly form the homogeneous mixture.

To that end, a flow ratio of the first injector 122a to the second injector 122b is determined to be from 5:1 to 5:5. The second injector 122b is designed to have small nozzle holes and small penetration. As regards the spread of spray, an angle formed between the cylinder center and the spray is about 40° and a spray angle is about 80°.

The flow rate of the first injector is determined so that sufficient fuel can be supplied into the cylinder 123 even at a middle and high-load. Because of spray for homogeneity, it is not indispensable that the spray is oriented toward the ignition plug 113, unlike the first example. The spray may be formed as diffusing spray beams to such an extent as not to adhere to the bore wall of the cylinder 123. Specifically, penetration is suppressed to have a general diameter of cylinder bore to form such spray to fall in the tumble retention cavity 108.

In the intake stroke of the engine, at first, the first injector 122a injects the spray 125a as shown in FIG. 19. Injection timing is designed to be from about 20° after top dead center to 20° before bottom dead center. This spray forms the homogeneous mixture 126a in the cylinder 123 via the intake stroke and compression stroke.

Next, in the compression stroke, the second injector 122b injects the spray 125b as shown in FIG. 20. The injection timing is from about 50° to 20° before top dead center. This spray is formed as compact spray near the ignition plug 113, thereby forming the stratified mixture 126b.

As with the first example, ignition is performed from about 5° to 30° after top dead center. As shown in FIG. 21, the stratified mixture 126b richer than the average stratified air-fuel ratio of the entire cylinder is stably present in the vicinity of the ignition plug 113 even at any crank angle. Therefore, stable combustion can be performed at any ignition timing. Incidentally, as with the first example, ignition may be performed a plurality of times in some instances.

In this way, the weak stratified mixture is formed in the entire cylinder 123 to suppress the diffusion of the mixture even at the time of ignition retard, thereby enabling stable combustion.

Usage under the other operating conditions is the same as that in the first example except that the usage of the injector is different depending on their positions; therefore, their explanations are omitted.

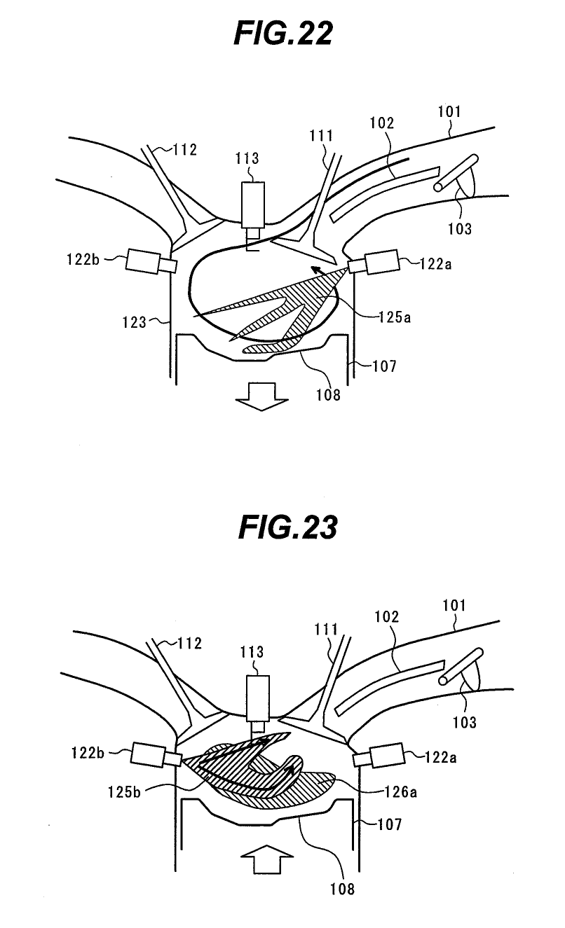

A description is next given of the state of the combustion chamber, in a third example, of the gasoline engine according to the present embodiment at the time of low-speed with low-load during cold-engine operation immediately after start-up, with reference to FIGS. 22 to 24.

FIGS. 22 to 24 are diagrams for assistance in explaining the state of the combustion chamber, in the third example, of the gasoline engine according to the embodiment of the present invention at the time of low-speed with low-load during cold-engine operation immediately after start-up. It is to be noted that in FIGS. 22 to 24, the same reference numerals as those in FIGS. 1 and 2 denote like portions.

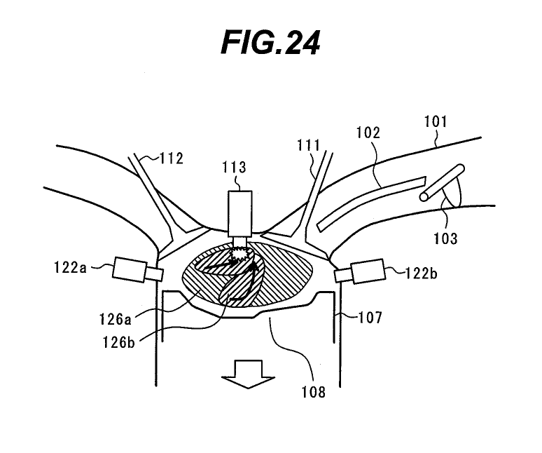

FIG. 22 illustrates the state of the intake stroke, FIG. 23 the state of the compression stroke, and FIG. 24 the state of an initial expansion stroke, i.e., of ignition timing.

A basic configuration is the same as those of the first and second examples. In the third example, the first injector 122a is disposed in the cylinder wall surface so as be put below and between the intake valves 111. In addition, the second injector 122b is disposed in the cylinder wall surface so as to be put below and between the exhaust valves 112.

The first injector 122a is used to mainly form the homogeneous mixture 126a and the second injector 122b is used to mainly form the stratified mixture 126b. Specifically, a flow ratio of the first injector 122a to the second injector 122b is determined to be from 5:1 to 5:5. In addition, among the sprays from the second injector, at least one spray is injected toward the vicinity of the ignition plug 113 and at least one of the remaining sprays is injected toward the upper portion of the cylinder 123 or toward the ignition plug 113 via the tumble retention cavity 108.

In addition, the first injector 122a is designed to have weak penetration and the second injector 122b is designed to have intense penetration.

Since the first injector 122a disposed close to the intake valves 111 is used to form the homogeneous mixture, the direction of spray is made downward compared with that of the second injector 122b so that the spray may proceed toward the tumble retention cavity 108.

As shown in FIG. 22, in the intake stroke of the engine, the first injector 122a disposed on the intake side injects the spray 125a. Ignition timing is designed to be from about 20° after top dead center to 20° before bottom dead center. This spray forms the homogeneous mixture 126a in the cylinder 123 through the intake stroke and through the compression stroke.

As shown in FIG. 23, in the compression stroke, the second injector 122b disposed on the exhaust side injects the spray 125b. Ignition timing is designed to be from about 50° to 20° before top dead center. This spray forms the stratified mixture 126b in the vicinity of the ignition plug 113.

Similarly to the first example, ignition is performed from about 5° to 30° after top dead center. As shown in FIG. 24, the stratified mixture 126b richer than the average air-fuel ratio of the entire cylinder is stably present in the vicinity of the ignition plug 113 even at any crank angle. Therefore, stable combustion can be performed at any ignition timing. Incidentally, the ignition may be performed at a plurality of times in some cases.

In this way, the weak stratified mixture is formed in the entire cylinder 123 to suppress the diffusion of the mixture even at the time of ignition retard, thereby providing stable combustion.

Usage under the other operating conditions is almost the same as those in the first and second examples; therefore, their explanations are omitted.

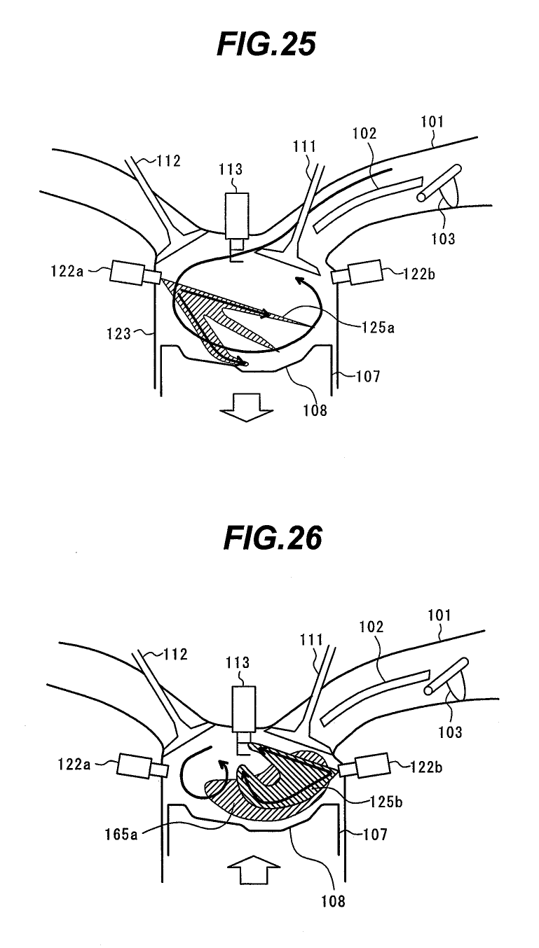

A description is next given of the state of the combustion chamber, in a fourth example, of the gasoline engine according to the present embodiment at the time of low-speed with low-load during cold-engine operation immediately after start-up, with reference to FIGS. 25 to 27.

FIGS. 25 to 27 are diagrams for assistance in explaining the state of the combustion chamber, in the fourth example, of the gasoline engine according to the embodiment of the present invention at the time of low-speed with low-load during cold-engine operation immediately after start-up. It is to be noted that in FIGS. 25 to 27, the same reference numerals as those in FIGS. 1 and 2 denote like portions.

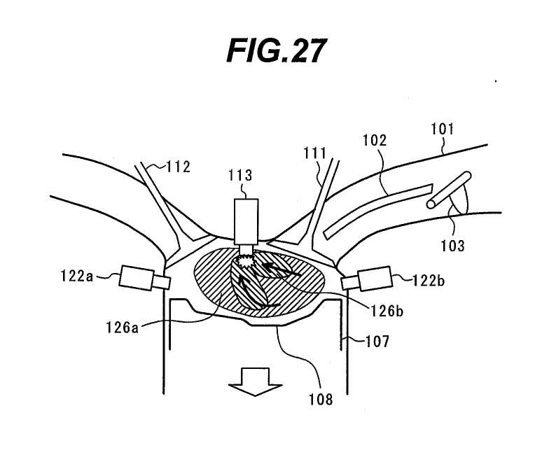

FIG. 25 illustrates the state of the intake stroke, FIG. 26 the state of the compression stroke, and FIG. 27 the state of an initial expansion stroke, i.e., of ignition timing.

A basic configuration is substantially the same as those of the examples of FIGS. 22 to 24. In the fourth example, the second injector 122b used to mainly form the stratified mixture is disposed in the cylinder wall surface so as to be put below and between the intake valves 111. In addition, the first injector 122a used to mainly form the homogeneous mixture is disposed in the cylinder wall surface so as to be put below and between the exhaust valves 112.

The first injector 122a is designed to have intense penetration and the second injector 122b is designed to have weak penetration.

The fourth example is almost the same as the third example except that the respective positions of the first and second injectors 122a, 122b are replaced with each other.

Also in this configuration, a weak stratified mixture can be formed inside the cylinder 123 so that stable ignition retard can be performed.

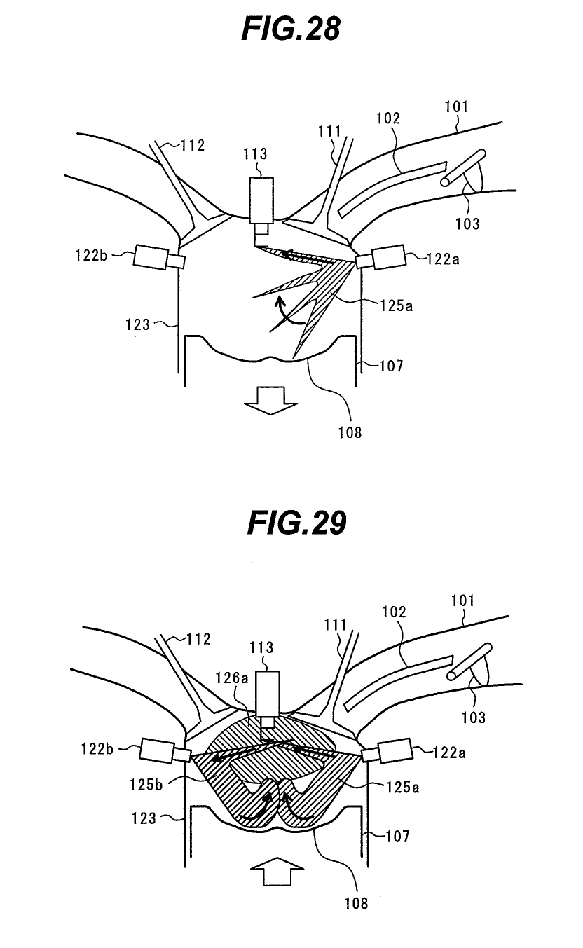

A description is next given of the state of the combustion chamber, in a fifth example, of the gasoline engine according to the present embodiment at the time of low-speed with low-load during cold-engine operation immediately after start-up, with reference to FIGS. 28 to 30.

FIGS. 28 to 30 are diagrams for assistance in explaining the state of the combustion chamber, in the fifth example, of the gasoline engine according to the embodiment of the present invention at the time of low-speed with low-load during cold-engine operation immediately after start-up. It is to be noted that in FIGS. 28 to 30, the same reference numerals as those in FIGS. 1 and 2 denote like portions.

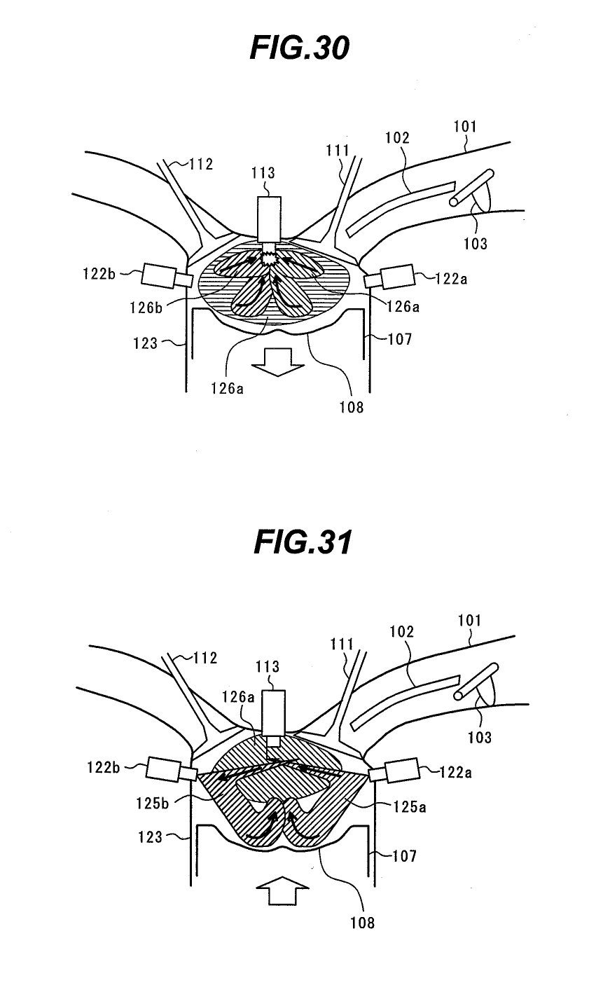

FIG. 28 illustrates the state of the intake stroke, FIG. 29 the state of the compression stroke, and FIG. 30 the state of an initial expansion stroke, i.e., of ignition timing.

A basic configuration is substantially the same as those of the third examples. That is to say, the first injector 122a is disposed close to the intake valves 111 and the second injectors 122b close to the exhaust valves 112. Unlike the examples described above, the first and second injectors 122a and 122b are almost the same in flow rate and in penetration. Of the sprays, at least one spray injected from each injector is made to proceed toward the ignition plug 113 and of the other remaining sprays, at least one spray is made to proceed toward the tumble retention cavity 108.

As shown in FIG. 29, in the intake stroke, the first injector 122a injects the fuel spray 125a and concurrently the second injector 122b may inject fuel if required. Preferably, injection timing is designed to be from 20° after top dead center to 20° before bottom dead center. The fuel thus injected forms a homogeneous mixture 126a inside the cylinder 120 through the intake stroke and through the compression stroke as shown in FIG. 30.

In the compression stroke, the first and second injectors 122a and 122b concurrently inject spray 125a and spray 125b, respectively, as shown in FIG. 29. Preferably, injection timing is designed to be from 50° to 20° before top dead center. The fuel concurrently injected collides with each other above the piston 107 or at the general center of the cylinder 120. The subsequent traveling direction of the spray is limited to the upside; therefore, the two sprays that have collided with each other curl up toward the ignition plug 113. In this way, in the expansion stroke shown in FIG. 30, preferably, at the time of 5° to 30° after top dead center, stratified mixtures 126b, 126c richer than the average air-fuel ratio of the entire cylinder can stably be formed in the vicinity of the ignition plug 113.

As described above, the injection in the intake and compression strokes are used to form the weak stratified mixture in the cylinder 123, thereby achieving stable ignition retard combustion.

With reference to FIG. 31, a description is next given of a state of the combustion chamber of the gasoline engine of the embodiment, at the low-speed with low-load after warm-up in the case where control is exercised on the low-speed with low-load during cold-engine operation immediately after start-up according to the fifth example.

FIG. 31 is a diagram for assistance in explaining the state of the combustion chamber of the gasoline engine of the embodiment of the present invention, at the low-speed with low-load after warm-up in the case where control is exercised on the low-speed with low-load during cold-engine operation immediately after start-up according to the fifth example. It is to be noted that in FIG. 31, the same reference numerals as those in FIGS. 1 and 2 denote like portions.

This case intends to form a stratified mixture unlike those illustrated in FIG. 28 to 30; therefore, fuel injection is performed only in the compression stroke, preferably, from 50° to 20° before top dead center. Also in this case, the first and second injectors 122a and 122b concurrently inject fuel to cause fuel sprays 125a, 125b to collide with each other at the tumble retention cavity 108 or at the general center of the cylinder 123. This can allow the sprays to curl up toward the vicinity of the ignition plug 113, thereby stably forming a stratified mixture in the vicinity of the ignition plug 113.

Usage under the other operating conditions is substantially the same as those in the first and second examples; therefore, their explanations are omitted.

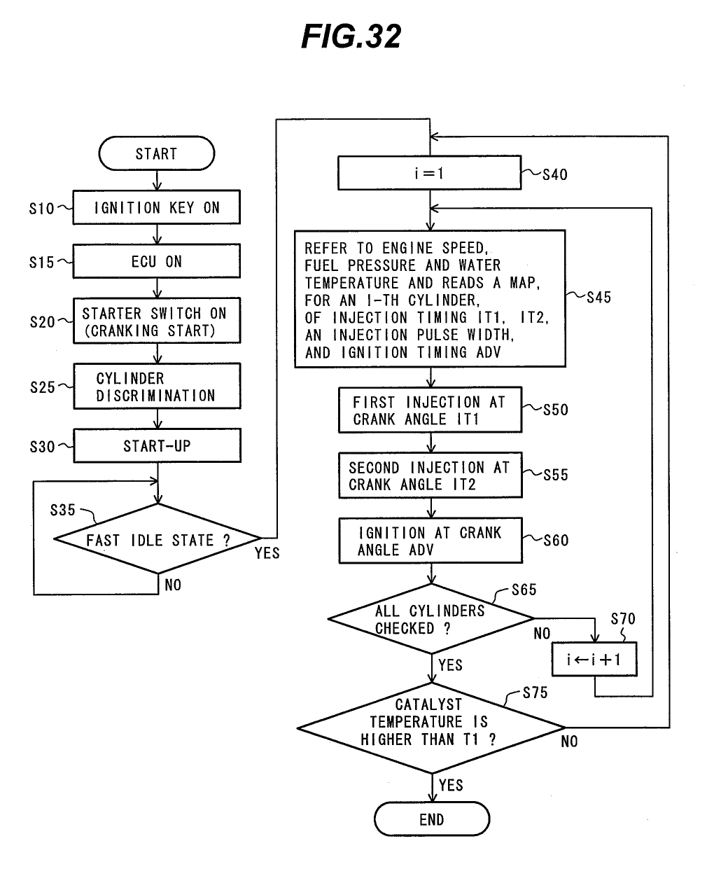

A description is next given of control contents exercised at the time of starting the gasoline engine according to the embodiment with reference to FIG. 32.

FIG. 32 is a flowchart illustrating the control contents exercised at the time of starting the gasoline engine according to the embodiment of the present invention.

When an ignition key is turned on in step S10, the engine control unit (ECU) 201 is energized in step S15.

Thereafter, a starter switch is turned on in step S20 to energize a starter motor, which starts cranking.

In step S25, the ECU 201 performs cylinder discrimination along with the rotation of the engine.

After the engine is started in step S30, the ECU 201 determines whether or not the engine is in a fast idle state.

If it is determined that the engine is in the fast idle state after start-up, the ECU 201 sets 1 at “i” in step S40. In addition, the ECU 201 refers to engine speed, fuel pressure and water temperature and reads a map, for an i-th cylinder, of injection timing IT1, IT2, an injection pulse width, and ignition timing ADV, which have been stored at the time of the engine was started during the previous cold-engine operation.

Using the values read in step S45, a first injection is performed at a crank angle IT1 in step S50, a second injection is performed at a crank angle IT2 in step S55, and ignition is performed at a crank angle ADV at step S60.

Next, the ECU 201 determines whether or not to finish checking all the cylinders in step S65. If it is determined that the checking has not been finished yet, the ECU 201 adds 1 to “i” in step S70, returns control to step S45, and executes steps S45 through S60 to retard ignition timing and fuel injection timing for each cylinder.

After the fuel injection and ignition are performed for all the cylinders, the ECU 201 determines whether or not a temperature condition for activating the catalyst is fulfilled referring to the temperature of the catalyst temperature sensor 303 or exhaust temperature sensor 304 in step S75. If the temperature condition is fulfilled, it is determined that the ignition timing retard control of the present invention is completed and control is moved to normal control. If the temperature of the catalyst temperature sensor 303 is not enough, control is returned to step S40 and fuel injection and ignition are performed sequentially from a first cylinder again until the increased temperature is fulfilled.

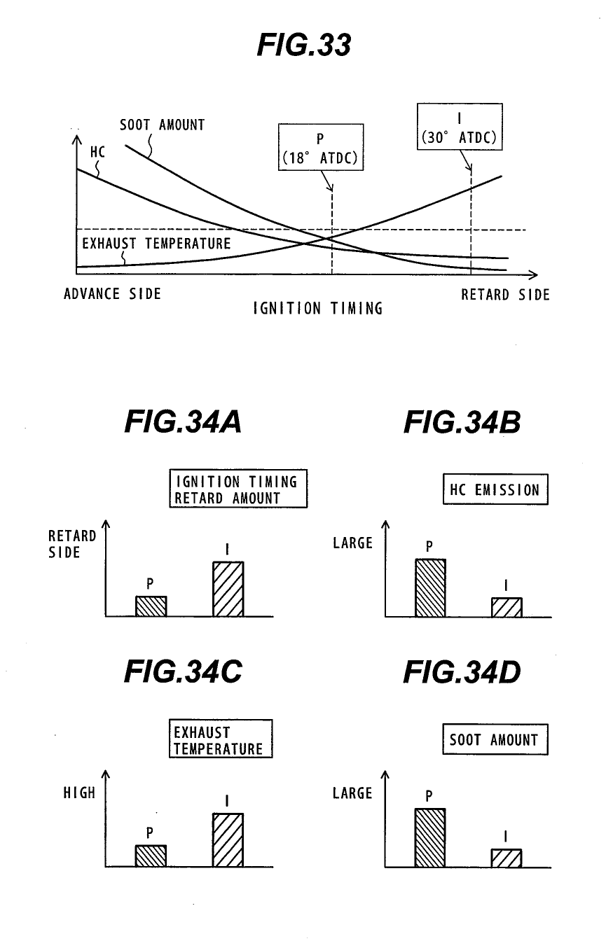

A description is next given of performance of a conventional example and of the embodiment with respect to the gasoline engine according to the embodiment at the time of low-speed with low-load after start-up with reference to FIGS. 33 and 34A through 34D.

FIG. 33 is a diagram for assistance in explaining a change in HC emissions, in soot amount and in exhaust temperature encountered when ignition timing is changed. FIG. 34 is a diagram for assistance in explaining performance of a conventional example and of the present embodiment at time of low-speed with low-load after start-up in the gasoline engine according to the embodiment.

In FIGS. 34A through 34D, FIG. 34A represents a retard amount at ignition timing and FIG. 34B HC emissions. In addition, FIG. 34C represents exhaust temperature and FIG. 34D an amount of soot. In the figures, symbol P denotes conventional performance and symbol I performance of the present embodiment.

In the present invention, a weak stratified mixture can be formed very satisfactorily; therefore, combustion is stable even if ignition timing is retarded. The ignition timing can further be retarded accordingly. Specifically, in FIG. 33, ignition timing in the conventional art is near 18° ATDC (after top dead center), whereas ignition timing in the present embodiment is near 30° ATDC.

Because of this, the exhaust temperature is high and afterburning is promoted as shown in FIG. 33; therefore, HC, if any, is burned out so that HC emissions from a tail pipe may be reduced as shown in FIG. 34B. In addition, the cooperation of the two injectors can prevent fuel from excessively adhering to the wall surface. Also in this point, the discharge of HC and of soot can be suppressed to a low level.

Incidentally, the embodiment thus far describes the configuration using the combination of the so-called lateral injection type injector with the direct-above type injector. However, the present invention is not limited to this. The following may be applicable: for example, three or four lateral-injection type injectors are arranged on the outer circumference of a cylinder; two lateral-injection type injectors are combined with a single direct-above type injector. These pluralizing configurations may clearly be embraced in the scope of the present invention.

As regards the injecting direction of each injector, although the present embodiment describes the combination of the upward direction with the downward direction, or of the downward directions, for the lateral-injection type injectors, the present invention is not limited to this. As long as the homogeneous or stratified mixture can efficiently be formed, both two injectors may face the upside of the cylinder for injection or opposite sprays may be injected so as to be divided rightward as viewed from above the cylinder. These configurations may be embraced within the scope of the present invention.

Further, as regards the injection timing of the injector, the two injections in the intake and compression strokes are described with respect to the ignition retard combustion immediately after start-up for example. However, in a range of not deteriorating emissions and combustion stability, for example, two injections in the compression and expansion strokes may be performed. In addition, for such two injections, it is sufficiently possible to set injection timings, the increase and decrease of the number of injections, each injector's injection timing, in various ways. Needless to say, these are embraced within the intended scope of the present invention.

The present embodiment describes the configuration in which the single ignition plug is disposed at the general center of the cylinder. However, the ignition plug may not necessarily be located at the center. If appropriate homogeneous and stratified mixtures can be formed, the ignition plug may be located at any position in the cylinder. In addition, the number of the ignition plugs may not be one but may be two or more. Even in such a case, using the configuration of the injectors as described in the embodiment, appropriate stratified and homogeneous mixtures can be formed. Needless to say, these may be embraced within the intended scope of the present invention.

The injector of the present invention may use not only the multi-hole injector but also a hollow-cone spray injector or an injector for injecting sector spray.

According to the present embodiment as described above, the two injectors are effectively used to increase the homogeneity of mixture at the time of high-load to thereby increase output power and stable operation can be performed even in performing stratified or weak stratified combustion.

That is to say, in the homogeneous combustion, homogeneity can be more increased than ever before to achieve an improvement in output power while suppressing emissions such as HC, etc., and soot. In the weak stratified combustion, a slightly lean base mixture is generated in the cylinder and a slightly rich mixture is stably generated in the vicinity of the ignition plug. This can improve flammability and initial combustion stability, which can improve the entire combustion stability. Thus, an improvement in fuel consumption and a reduction in emissions can be achieved.

In retard combustion at the time of start-up, since the mixture formation can be optimized, a sufficient amount of ignition retard can be ensured immediately after start-up to increase exhaust temperature. This achieves the early activation of the catalyst and reduces HC and ensures the long evaporation time of fuel, thereby providing reduced soot.

Further, while supplying sufficient fuel also in a high-speed and high-load range or in performing supercharging, the controllability of the minimum flow rate of the injector can be ensured even under a low-load condition such as at idling time, that is, the so-called dynamic range can be increased.

In addition, since the flow rate of the injector for stratified combustion is reduced, the atomization of fuel can be achieved compared than before to thereby improve evaporation. This can reduce fuel adhering to the wall surface and emissions such as HC, soot, etc.

1. A gasoline engine for injecting fuel directly to cylinders by injectors,
wherein two injectors are provided for each cylinder, and
one or both the injectors are used for fuel injection within one combustion cycle depending on an operating condition.

2. The gasoline engine according to claim 1,
wherein the two injectors are used to form a weak stratified mixture in the entire cylinder during cold-engine operation immediately after start-up, and a mixture richer than an average air-fuel ratio of the entire cylinder around an ignition plug.

3. The gasoline engine according to claim 1,
wherein of the two injectors, a first injector is disposed above a combustion chamber to open in the vicinity of the center of a cylinder, and a second injector is disposed to open at a position below the cylinder and between two intake ports.

4. The gasoline engine according to claim 1,
wherein of the two injectors, a first injector is disposed to open at a position below a cylinder and between two intake ports and a second injector is disposed to open at a position below a cylinder and between two exhaust ports.

5. The gasoline engine according to claim 3,
wherein one of the two injectors has a spraying direction faced upward of the cylinder, i.e., toward the direction of the cylinder, and the other has a spraying direction faced downward of the cylinder i.e., toward the direction of a piston.

6. The gasoline engine according to claim 3,
wherein of the two injectors, one located above the combustion chamber or close to the exhaust ports is made to have weak penetration and the other located close to the intake ports is made to have intense penetration.

7. The gasoline engine according to claim 3,
wherein of the two injectors, one located above the combustion chamber or close to the exhaust ports is made to have intense penetration and the other located close to the intake ports is made to have weak penetration.

8. The gasoline engine according to claim 3, wherein if the engine is mainly operated on stratified combustion, of the two injectors, only one located above the combustion chamber performs fuel injection and if the engine is operated on homogeneous combustion, both the two injectors perform fuel injection.

9. The gasoline engine according to claim 1, wherein of the two injectors, an injector mainly used for intake stroke injection has a flow rate different from that of the other injector and an injector mainly used for compression stroke injection has a nozzle hole diameter and the number of nozzle holes different from those of the other injector.

10. The gasoline engine according to claim 1, wherein respective pressures of fuel supplied to the two injectors are made different from each other.

11. A gasoline engine for injecting fuel directly to cylinders by injectors,
wherein two injectors are provided for each cylinder, and
the two injectors are used to form a weak stratified mixture in the entire cylinder during cold-engine operation immediately after start-up, and a mixture richer than an average air-fuel ratio of the entire cylinder around an ignition plug.

12. The gasoline engine according to claim 4,
wherein one of the two injectors has a spraying direction faced upward of the cylinder, i.e., toward the direction of the cylinder, and the other has a spraying direction faced downward of the cylinder i.e., toward the direction of a piston.

13. The gasoline engine according to claim 4,
wherein of the two injectors, one located above the combustion chamber or close to the exhaust ports is made to have weak penetration and the other located close to the intake ports is made to have intense penetration.

14. The gasoline engine according to claim 4,
wherein of the two injectors, one located above the combustion chamber or close to the exhaust ports is made to have intense penetration and the other located close to the intake ports is made to have weak penetration.
